(19) United States
(12) Patent Application Publication
(10) Pub. No.: US 2025/0388325 A1
(43) Pub. Date: Dec. 25, 2025

(54) LATERAL FLEXION HEADREST FOR PASSENGER SEATS

(71) Applicant: B/E Aerospace, Inc., Winston-Salem, NC (US)

(72) Inventors: Gopal Parthasarathy, Hyderabad (IN); Kiran Babu P, Chittoor, Andhara Pradesh (IN); Pandiyarajan Raju, Madurai (IN); Jayavenkatesh Tamilarasan, Kurnool (IN)

(21) Appl. No.: 19/235,267

(22) Filed: Jun. 11, 2025

(30) Foreign Application Priority Data
Jun. 21, 2024 (IN) 202441047901

(51) Int. Cl. B64D 11/06

(52) U.S. Cl. CPC B64D 11/0642

(57) ABSTRACT

A headrest assembly for a passenger seat such as an aircraft passenger seat. A disc mountable to a passenger seat includes a curved guide having a first end and a second end. A headrest is rotatably mounted to the disc and includes first and second headrest mounting pins movably disposed in the curved guide. A first compression spring is disposed in the curved guide positioned between the first headrest mounting pin and the first end. A second compression spring is disposed in the curved guide positioned between the second headrest mounting pin and the second end. In use, starting from a neutral position of the headrest, the headrest is rotatable relative to the disc in a first direction corresponding to lateral flexion in the first direction, and the headrest is rotatable relative to the disc in a second direction corresponding to lateral flexion in the second direction.

### CROSS REFERENCE AND RELATED APPLICATION

This application claims the benefit of priority of Indian Provisional Application No. 20/244,1047901 filed Jun. 21, 2024 for LATERAL FLEXION HEADREST FOR PASSENGER SEATS, which is hereby incorporated by reference in its entirety.

### TECHNICAL FIELD AND BACKGROUND

The present disclosure relates generally to a headrest for passenger seats, and more particularly, to a spring-loaded lateral flexion headrest for improving comfort and alleviating neck stiffness from prolonged sitting.

Passenger seats for airliners and other conveyances are typically equipped with headrests for sitting comfort and for safety in the event of a crash or sudden deceleration. Some headrests may be vertically adjustable, while other headrests may further include features for lateral adjustability, for instance pivoting lateral supports. In use, a vertically adjustable headrest may be raised or lowered depending on the height of the passenger, and lateral supports may be deployed forward for sleeping.

Traditional headrest adjustment mechanisms are mechanical and designed to maintain their adjusted position(s). As such, returning the headrest to a ‘starting’ or ‘neutral’ position requires manually adjusting the moved headrest components back to their original positions. Such a mechanism requires action by the user to return the headrest to the neutral position, and action by the crew between flights to confirm the former passenger action was taken. In addition, the laterally adjustable portions of traditional headrests adjust forward to provide a provision for sleeping, and do not address lateral flexion associated with the neck and spine. It is well known that awkward head and neck movements, as well as maintaining the same head position over a long period of time (e.g., overnight sleeping), can result in head and neck stiffness.

Accordingly, what is needed is a headrest that permits lateral flexion with a design that automatically returns the headrest to a neutral position between lateral flexions and/or uses.

### BRIEF SUMMARY

According to one aspect, the inventive concepts according to the present disclosure are directed to a headrest assembly for mounting to a passenger seat such as an aircraft passenger seat. In embodiments, the headrest assembly includes a disc mountable to a passenger seat and including a curved guide having a first end and a second end, and a headrest rotatably mounted to the disc, the headrest including first and second headrest mounting pins movably disposed in the curved guide. The assembly further includes a first compression spring disposed in the curved guide positioned between the first headrest mounting pin and the first end of the curved guide, and a second compression spring disposed in the curved guide positioned between the second headrest mounting pin and the second end of the curved guide. In use, starting from a neutral position of the headrest, the headrest is rotatable relative to the disc in a first direction corresponding to lateral flexion in the first direction, and the headrest is rotatable relative to the disc in a second direction corresponding to lateral flexion in the second direction.

In some embodiments, the first compression spring is attached at one end to the first headrest mounting pin and at an opposing end to the first end of the curved guide such that headrest rotation in the first direction causes the first compression spring to compress and headrest rotation in the second direction causes the first compression spring to elongate, and the second compression spring is attached at one end to the second headrest mounting pin and at an opposing end to the second end of the curved guide such that headrest rotation in the second direction causes the second compression spring to compress and headrest rotation in the first direction causes second compression spring to elongate.

In some embodiments, when the headrest rotates in the first direction an amount of compression of the first compression spring is equal to an amount of elongation of the second compression spring, and when the headrest rotates in the second direction an amount of compression of the second compression spring is equal to an amount of elongation of the first compression spring.

In some embodiments, when no rotational force is applied to the headrest, the first and second compression springs operate to maintain the headrest in the neutral position.

In some embodiments, the curved guide is circular, and the headrest rotates about a center axis of the curved guide.

In some embodiments, headrest rotation in the first direction, starting from the neutral position, is no more than about 30 degrees, and headrest rotation in the second direction, starting from the neutral position, is no more than about 30 degrees.

In some embodiments, the headrest includes a center portion mounted to the first headrest pin and the second headrest pin, a first lateral portion pivotally mounted to a first side of the center portion, and a second lateral portion pivotally mounted to a second side of the center portion, wherein the first lateral portion and the second lateral portion are independently pivotable relative to the center portion.

According to another aspect, the inventive concepts according to the present disclosure are directed to an aircraft passenger seat assembly including a seat back and a headrest assembly. In embodiments, the headrest assembly includes a disc mounted to the seat back and including a curved guide having a first end and a second end, and a headrest rotatably mounted to the disc, the headrest including first and second headrest mounting pins movably disposed in the curved guide. The assembly further includes a first compression spring disposed in the curved guide positioned between the first headrest mounting pin and the first end of the curved guide, and a second compression spring disposed in the curved guide positioned between the second headrest mounting pin and the second end of the curved guide. In use, starting from a neutral position of the headrest, the headrest is rotatable relative to the disc in a first direction corresponding to lateral flexion in the first direction, and the headrest is rotatable relative to the disc in a second direction corresponding to lateral flexion in the second direction.

This summary is provided solely as an introduction to subject matter that is fully described in the following detailed description and drawing figures. This summary should not be considered to describe essential features nor be used to determine the scope of the claims. Moreover, it is to be understood that both the foregoing summary and the following detailed description are explanatory only and are not necessarily restrictive of the subject matter claimed.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is an isometric view of a lateral flexion headrest assembly, in accordance with example embodiments of this disclosure;

FIG. 2 is a fragmentary isometric view of a passenger seat assembly including a disc for rotatably mounting a lateral flexion headrest, in accordance with example embodiments of this disclosure;

FIG. 3 is an exploded view of a subassembly of the lateral flexion headrest assembly, in accordance with example embodiments of this disclosure;

FIG. 4A is a front view of a passenger seat assembly including the lateral flexion headrest assembly shown rotated in a first direction corresponding to the ‘right’, in accordance with example embodiments of this disclosure; and

FIG. 4B is a front view of a passenger seat assembly including the lateral flexion headrest assembly shown rotated in a second direction corresponding to the ‘left’, in accordance with example embodiments of this disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a headrest assembly for mounting to a passenger seat, and a passenger seat assembly including a headrest assembly. The passenger seat may be for an aircraft/airliner, or for another type of vehicle or even a chair. The headrest assembly generally includes a headrest rotatably mounted to a fixed structure mountable to the passenger seat, for instance to the front of a seat back. The headrest is configured to rotate left (e.g., clockwise) and right (e.g., counterclockwise) depending on passenger preference. The headrest is spring-loaded such that the rotational to either side compresses one spring while simultaneously elongating another spring such that springs act opposite to return the headrest to a neutral position in the absence of a rotational force. The rotatably headrest is compatible for use with other headrest adjustment mechanisms including, but not limited to, vertical adjustment mechanisms, vertical axis tilt mechanisms, and pivoting lateral support mechanisms, independent or synchronous.

In use, the motion path of the headrest left or right corresponds to respective left lateral flexion and right lateral flexion motions (i.e., head movement toward one shoulder). The spring force may be tuned such that minimal force is required to rotate the headrest in either direction to provide a sleeping provision. In another example, the spring force may be increased such that the force required to rotate the headrest is an exercise force and the passenger may rotate the headrest back and forth during flight to exercise their neck muscles to prevent stiffness and pain common when in the same position for a prolonged period of time (e.g., long haul overseas flight).

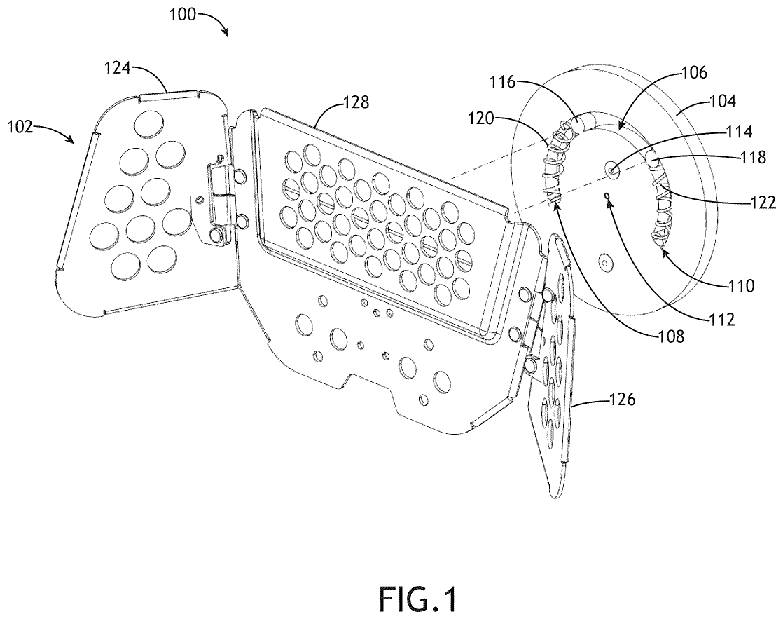

FIG. 1 illustrates a particular conceived example of a headrest assembly 100 according to the present disclosure. The headrest assembly 100 generally includes a headrest 102 rotatably mounted to a disc 104 mountable to a passenger seat, for instance to a front of a seat back. The disc 104 may in turn be fixed in position to the passenger seat or mounted to a further adjustment mechanism such as a vertical adjustment mechanism. The movement, or lack thereof, of the disc 104 relative to the passenger seat is not critical so long as the headrest 102 is able to rotate relative to the disc 104. The term “disc” as used herein is not intended to denote any particular shape. While a round disc is shown consider a circular feature, the disc may be square, rectangular, triangular, or a combination shape.

The disc 104 includes a guide 106. As shown, the guide 106 is curved such as circular, but not a complete circle such that the curved guide has a first end 108 and a second end 110. A rotational center of the curved guide 106 is shown at 112, and the headrest 102 rotates about the rotational center 112. As shown, the disc 104 is mountable to a passenger seat by two fasteners 114 positioned spaced apart to prevent rotation of the disc 104 relative to the passenger seat.

The headrest 102 is mounted to a pair of mounting pins including a first headrest mounting pin 116 and a second headrest mounted pin 118. Each of the first and second mounting pins 116, 118 is fixed to the headrest and is movably disposed in the curved guide 106. In embodiments, the movement may be sliding motion or a rolling motion in the case of vertically mounted rollers. The first and second headrest mounting pins 116 are positioned in the curved guide 106 favored to one side which corresponds to motion of the respective side. As shown, from a user perspective, the first headrest mounting pin 116 is favored toward the right lateral flexion direction, and the second headrest mounting pin 118 is favored toward the left lateral flexion direction.

The headrest assembly 100 further includes a first compression spring 120 and a second compression spring 122 each disposed in the curved guide 106. The first compression spring 120 is positioned to act between the first headrest mounting pin 116 and the first end 108 of the curved guide 106. The second compression spring 122 is positioned to act between the second headrest mounting pin 118 and the second end 110 of the curved guide 106. In some embodiments, the ends of the compression springs 102, 122 may be detached from their respective engagements such the second compression spring 122 is not involved in the right lateral flexion motion and the first compression spring 120 is not involved in the left lateral flexion motion. In this detached configuration, one compression spring operates to both resist lateral flexion in its direction and return the headrest 102 to a neutral position without assistance from the other compression spring. FIG. 1 illustrates the neutral position of the headrest 102 in which the headrest is horizontal or substantially horizontal and neither compression spring 120, 122 is compressed or elongated.

FIG. 1 shows a particular conceived example of a headrest 102 including a first (e.g., right) lateral support 124, and a second (e.g., left) lateral support 126. Each lateral support 124, 126 is pivotally attached to a headrest center portion 128 which is in turn rotatably mounted to the disc 106. In use, the lateral supports 124, 126 are independently or synchronously manually adjustable forward to provide a side support for sleeping. In some embodiments, the center position 128 and the lateral supports 124, 126 may be integrally formed and not adjustable. Each of the center portion 128 and the lateral portions 124, 126 are shown as being foraminous for weight reduction.

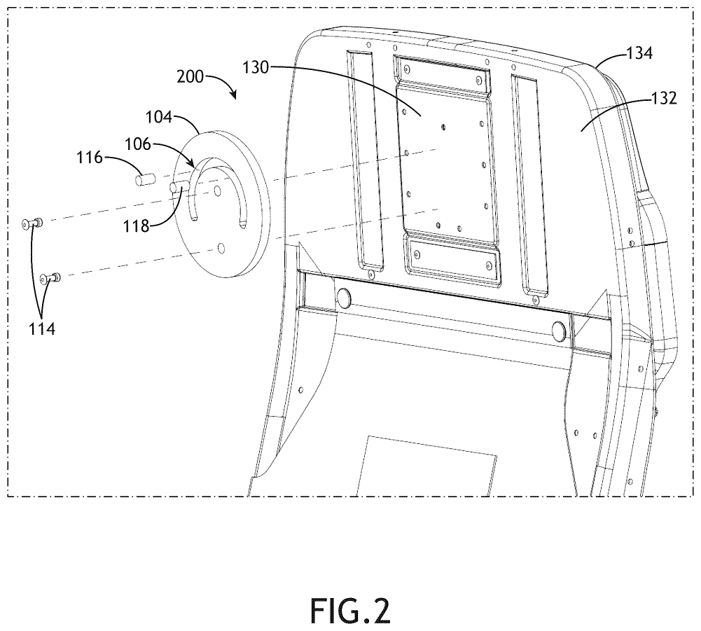

FIG. 2 illustrates a passenger seat assembly 200 including the headrest assembly 100 as described above. As shown, the disc 104 is mounted to a plate 130 positioned on a front of a seat back 132 of a passenger seat 134. The disc 104 mounts to the plate 130 such that the curved guide 106 opens ‘downward’. The fasteners 114 fixedly mount the disc 104 to the plate 130, and the first and second headrest mounting pins 116, 118 rotatably mount the headrest (not shown) to the disc 104. The first and second headrest mounting pins 116, 118 are preferably configured to moveable engage in the curved guide 106 while preventing the headrest from being pulled apart from the disc 104.

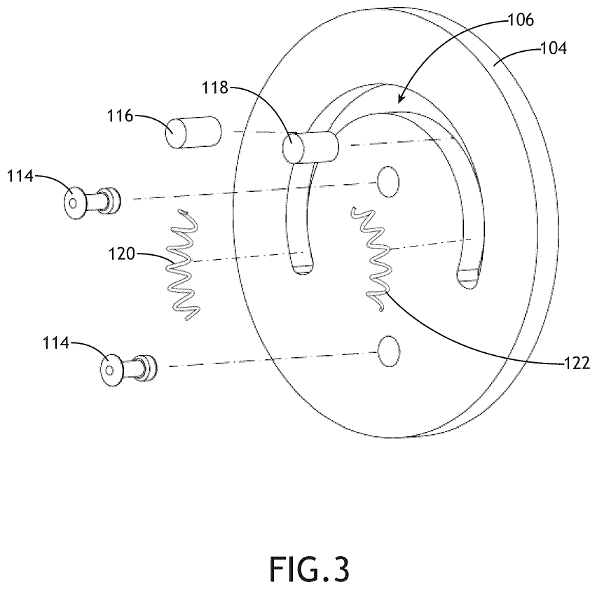

FIG. 3 illustrates the configuration and positional relationships of the disc 104, curved guide 106, first and second headrest mounting pins 116, 118, first and second compression springs 120, 122, and fasteners. In embodiments, the first and second compression springs 120, 122 are curved or made to curve to follow the curvature of the curved guide 106.

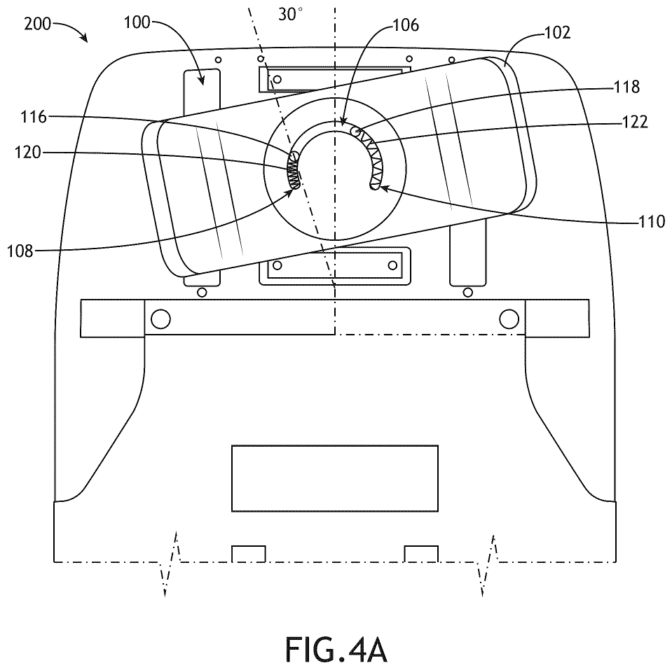

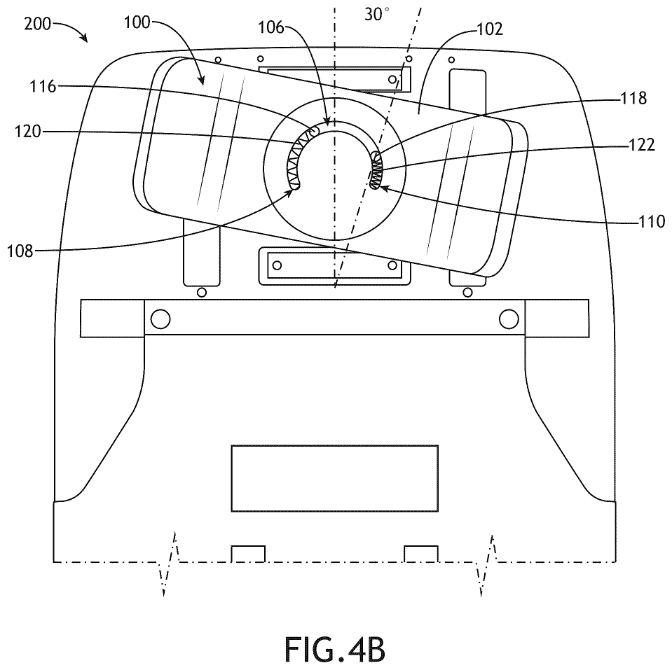

FIG. 4A illustrates another example of a configuration for the passenger seat assembly 200 and headrest assembly 100 shown rotated in a first direction corresponding to lateral flexion to the right. The headrest 102 is shown including integrally formed lateral portions. As further shown, the first compression spring 120 is attached at one end to the first headrest mounting pin 116, and at an opposing end to the first end 108 of the curved guide 106. The second compression spring 122 is attached at one end to the second headrest mounting pin 118, and at an opposing end to the second end 110 of the curved guide. By including attached spring ends, as the headrest rotates in the first direction corresponding to right lateral flexion, the first compression spring 120 compresses and the second compression spring 122 simultaneously elongates.

In a symmetrical configuration with like compression springs, when the headrest rotates in the first direction, an amount of compression of the first compression spring 120 is equal to an amount of elongation of the second compression spring 122. Thus, when no rotational force is applied to the headrest 102, the first and second compression springs 120, 122 operate opposite to maintain the headrest 102 in the neutral position. More specifically, in the absence of a rotational force, the compressed first compression spring 120 wants to return to an uncompressed state, and the elongated second compression spring 122 wants to return to an unelongated state. In embodiments, the maximum rotation from the neutral position to the full right lateral flexion may be no more than 45 degrees, more preferably no more than 35 degrees, and most preferably about 30 degrees.

FIG. 4B illustrates the configuration of FIG. 4A shown rotated in a second direction corresponding to lateral flexion to the left. Again, the first compression spring 120 is attached at one end to the first headrest mounting pin 116, and at an opposing end to the first end 108 of the curved guide 106. The second compression spring 122 is attached at one end to the second headrest mounting pin 118, and at an opposing end to the second end 110 of the curved guide. By including attached spring ends, as the headrest rotates in the second direction corresponding to left lateral flexion, the second compression spring 122 compresses and the first compression spring 120 simultaneously elongates.

In the symmetrical configuration with like compression springs, when the headrest rotates in the second direction, an amount of compression of the second compression spring 122 is equal to an amount of elongation of the first compression spring 120. Thus, when no rotational force is applied to the headrest 102, the first and second compression springs 120, 122 operate opposite to maintain the headrest 102 in the neutral position. More specifically, in the absence of a rotational force, the compressed second compression spring 122 wants to return to an uncompressed state, and the elongated first compression spring 120 wants to return to an unelongated state. In embodiments, the maximum rotation from the neutral position to the full left lateral flexion may be no more than 45 degrees, more preferably no more than 35 degrees, and most preferably about 30 degrees. The compression springs 120, 122 may be tuned to have a particular spring force to resist and return rotation, and the length of the curved guide 106 may be determinative of the amount of angular rotation in opposite directions. Thus, the performance of the assembly 100 in terms of motion and force required to perform the motion may be customized, and the headrest 102 may be customized in terms of padding, aesthetics, further adjustability, etc.

From the above description, it is clear that the inventive concepts disclosed herein are well adapted to achieve the objectives and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A headrest assembly, comprising:
a disc mountable to a passenger seat, the disc including a curved guide having a first end and a second end;
a headrest rotatably mounted to the disc, the headrest including a first headrest mounting pin movably disposed in the curved guide, and a second headrest mounting pin movably disposed in the curved guide;
a first compression spring disposed in the curved guide positioned between the first headrest mounting pin and the first end of the curved guide; and
a second compression spring disposed in the curved guide positioned between the second headrest mounting pin and the second end of the curved guide;
wherein, in use starting from a neutral position of the headrest:
the headrest is rotatable relative to the disc in a first direction corresponding to lateral flexion in the first direction; and
the headrest is rotatable relative to the disc in a second direction corresponding to lateral flexion in the second direction.

2. The headrest assembly according to claim 1, wherein:
the first compression spring is attached at one end to the first headrest mounting pin, and at an opposing end to the first end of the curved guide, such that headrest rotation in the first direction causes the first compression spring to compress, and headrest rotation in the second direction causes the first compression spring to elongate; and
the second compression spring is attached at one end to the second headrest mounting pin, and at an opposing end to the second end of the curved guide, such that headrest rotation in the second direction causes the second compression spring to compress, and headrest rotation in the first direction causes second compression spring to elongate.

3. The headrest assembly according to claim 1, wherein:
when the headrest rotates in the first direction, an amount of compression of the first compression spring is equal to an amount of elongation of the second compression spring; and
when the headrest rotates in the second direction, an amount of compression of the second compression spring is equal to an amount of elongation of the first compression spring.

4. The headrest assembly according to claim 1, wherein, when no rotational force is applied to the headrest, the first and second compression springs operate to maintain the headrest in the neutral position.

5. The headrest assembly according to claim 1, wherein the curved guide is circular, and the headrest rotates about a center axis of the curved guide.

6. The headrest assembly according to claim 1, wherein:
headrest rotation in the first direction, starting from the neutral position, is no more than about 30 degrees; and
headrest rotation in the second direction, starting from the neutral position, is no more than about 30 degrees.

7. The headrest assembly according to claim 1, wherein the headrest comprises:
a center portion mounted to the first headrest pin and to the second headrest pin;
a first lateral portion pivotally mounted to a first side of the center portion; and
a second lateral portion pivotally mounted to a second side of the center portion;
wherein the first lateral portion and the second lateral portion are independently pivotable relative to the center portion.

8. An aircraft passenger seat assembly, comprising:
a seat back; and
a headrest assembly, comprising:
a disc mountable to a front of the seat back, the disc including a curved guide having a first end and a second end;
a headrest rotatably mounted to the disc, the headrest including a first headrest mounting pin movably disposed in the curved guide, and a second headrest mounting pin movably disposed in the curved guide;
a first compression spring disposed in the curved guide positioned between the first headrest mounting pin and the first end of the curved guide; and
a second compression spring disposed in the curved guide positioned between the second headrest mounting pin and the second end of the curved guide;
wherein, in use starting from a neutral position of the headrest:
the headrest is rotatable relative to the disc in a first direction corresponding to lateral flexion in the first direction; and
the headrest is rotatable relative to the disc in a second direction corresponding to lateral flexion in the second direction.

9. The aircraft passenger seat assembly according to claim 8, wherein:
the first compression spring is attached at one end to the first headrest mounting pin, and at an opposing end to the first end of the curved guide, such that headrest rotation in the first direction causes the first compression spring to compress, and headrest rotation in the second direction causes the first compression spring to elongate; and
the second compression spring is attached at one end to the second headrest mounting pin, and at an opposing end to the second end of the curved guide, such that headrest rotation in the second direction causes the second compression spring to compress, and headrest rotation in the first direction causes second compression spring to elongate.

10. The aircraft passenger seat assembly according to claim 8, wherein:
when the headrest rotates in the first direction, an amount of compression of the first compression spring is equal to an amount of elongation of the second compression spring; and
when the headrest rotates in the second direction, an amount of compression of the second compression spring is equal to an amount of elongation of the first compression spring.

11. The aircraft passenger seat assembly according to claim 8, wherein, when no rotational force is applied to the headrest, the first and second compression springs operate to maintain the headrest in the neutral position.

12. The aircraft passenger seat assembly according to claim 8, wherein the curved guide is circular, and the headrest rotates about a center axis of the curved guide.

13. The aircraft passenger seat assembly according to claim 8, wherein:
headrest rotation in the first direction, starting from the neutral position, is no more than about 30 degrees; and
headrest rotation in the second direction, starting from the neutral position, is no more than about 30 degrees.

14. The aircraft passenger seat assembly according to claim 8, wherein the headrest comprises:
a center portion mounted to the first headrest pin and the second headrest pin;
a first lateral portion pivotally mounted to a first side of the center portion; and
a second lateral portion pivotally mounted to a second side of the center portion;
wherein the first lateral portion and the second lateral portion are independently pivotable relative to the center portion.

15. A headrest assembly for mounting to an aircraft passenger seat, the headrest assembly comprising:
a base including a curved guide having a first end and a second end, the curved guide forming at least a semicircle;
a headrest rotatably mounted to the base, the headrest including a first headrest mounting pin movably disposed in the curved guide, and a second headrest mounting pin movably disposed in the curved guide;
a first compression spring disposed in the curved guide positioned between the first headrest mounting pin and the first end of the curved guide; and
a second compression spring disposed in the curved guide positioned between the second headrest mounting pin and the second end of the curved guide;
wherein, in use starting from a neutral position of the headrest:
the headrest is rotatable relative to the base in a clockwise direction corresponding to lateral flexion in the clockwise direction; and
the headrest is rotatable relative to the disc in a counterclockwise direction corresponding to lateral flexion in the counterclockwise direction.

16. The headrest assembly according to claim 15, wherein:
the first compression spring is attached at one end to the first headrest mounting pin, and at an opposing end to the first end of the curved guide, such that headrest rotation in the clockwise direction causes the first compression spring to compress, and headrest rotation in the counterclockwise direction causes the first compression spring to elongate; and
the second compression spring is attached at one end to the second headrest mounting pin, and at an opposing end to the second end of the curved guide, such that headrest rotation in the counterclockwise direction causes the second compression spring to compress, and headrest rotation in the clockwise direction causes second compression spring to elongate.

17. The headrest assembly according to claim 15, wherein:
when the headrest rotates in the clockwise direction, an amount of compression of the first compression spring is equal to an amount of elongation of the second compression spring; and
when the headrest rotates in the counterclockwise direction, an amount of compression of the second compression spring is equal to an amount of elongation of the first compression spring.

18. The headrest assembly according to claim 15, wherein, in the absence of rotational force applied to the headrest, the first and second compression springs operate to maintain the headrest in the neutral position.

19. The headrest assembly according to claim 15, wherein:
the headrest rotates about a center axis of the curved guide;
headrest rotation in the clockwise direction, starting from the neutral position, is no more than about 30 degrees; and
headrest rotation in the counterclockwise direction, starting from the neutral position, is no more than about 30 degrees.

20. The headrest assembly according to claim 15, wherein the headrest comprises:
a center portion mounted to the first headrest pin and to the second headrest pin;
a first lateral portion pivotally mounted to a first side of the center portion; and
a second lateral portion pivotally mounted to a second side of the center portion;
wherein the first lateral portion and the second lateral portion are independently pivotable relative to the center portion.
